(19) United States
(12) Patent Application Publication
(10) Pub. No.: US 2026/0163354 A1
(43) Pub. Date: Jun. 11, 2026

(54) CIRCUIT PROTECTION WITH SOLID-STATE DEVICE BYPASS AND FUSE

(71) Applicant: Sensata Technologies, Inc., Attleboro, MA (US)

(72) Inventor: Thomas Gerjen Hendrik Kouwen, Ojai, CA (US)

(73) Assignee: Sensata Technologies, Inc., Attleboro, MA (US)

(21) Appl. No.: 19/414,065

(22) Filed: Dec. 9, 2025

Related U.S. Application Data
(60) Provisional application No. 63/730,774, filed on Dec. 11, 2024.

(51) Int. Cl. H02H 3/08; H01H 71/10; H01H 71/12; H01H 85/02; H01H 85/042; H02H 3/033

(52) U.S. Cl. CPC H02H 3/08; H01H 71/1009; H01H 71/123; H01H 85/042; H02H 3/033; H01H 2085/0283

(57) ABSTRACT

A protection circuit may include a fuse configured to couple in series with a load. The protection circuit may include a device coupled to the fuse and configured to couple in parallel with the load. The device may be configured to, in response to an increase in current above a threshold, operate in an active state to route at least a portion of the current through the device and to the fuse. In examples, the device includes a solid-state device, a mechanically-actuated device, and/or a pyro-actuated device.

### CROSS REFERENCE TO RELATED PATENT APPLICATION

This application claims the benefit of Provisional Application No. 63/730,774, titled “CIRCUIT PROTECTION WITH SOLID-STATE DEVICE BYPASS AND FUSE,” filed Dec. 11, 2024, which is hereby incorporated by reference in its entirety.

### BACKGROUND

High power density batteries are increasingly used in applications demanding rapid energy delivery, such as electric vehicles, power tools, and aerospace systems. These batteries are designed to provide significant power output while maintaining compact size and efficiency. However, these same characteristics amplify the risks associated with electrical faults, such as short circuits, which can result in uncontrolled current surges, overheating, and potential thermal runaway. The difference between the power the battery is designed to deliver during typical operation and the potentially enormous power it can release during a short circuit is growing. Safety mechanisms, including fuses, current limiters, and battery management systems, often struggle to balance the trade-off between ensuring operational performance and mitigating overcurrent. For instance, even the fastest fuses can take considerable time to interrupt a circuit, allowing current to travel through the fuse and damage components of a system.

### BRIEF DESCRIPTION OF THE DRAWINGS

Various examples are depicted in the accompanying drawings for illustrative purposes and should in no way be interpreted as limiting the scope of the disclosure. In addition, various features of different disclosed examples can be combined to form additional examples, which are part of this disclosure. Throughout the drawings, reference numbers may be reused to indicate correspondence between reference elements.

FIG. 1 illustrates an example protection circuit configured to protect a load against an overcurrent according to one or more examples.

FIG. 2 illustrates an example protection circuit that includes a relay to control power provided to a load and control circuitry to control a state of a solid-state device according to one or more examples.

FIGS. 3A-3C illustrate example states of a protection circuit during an overcurrent event according to one or more examples.

FIG. 4 illustrates an example where a protection circuit includes a fuse coupled between a power source and a solid-state device according to one or more examples.

### DETAILED DESCRIPTION

This disclosure relates to systems, techniques, and devices for quickly handling an undesired overcurrent, such as to protect components from damage that may be caused from the overcurrent. For example, a system can include a fuse configured to couple in series with a load and a solid-state device configured to couple in parallel with the load. In response to an overcurrent, the solid-state device can quickly activate to cause at least a portion of the overcurrent to bypass the load and travel to the fuse. The overcurrent can activate the fuse causing the fuse to interrupt the circuit and inhibit current flow. In examples, the solid-state device can be configured to activate relatively quickly to reroute at least a portion of the overcurrent to the fuse (e.g., reroute the overcurrent in less than a threshold amount of time from the onset of the overcurrent). Further, the fuse can be configured to activate more slowly to interrupt the circuit (e.g., interrupt the circuit in more than the threshold amount of time from the onset of the overcurrent through the fuse). By rerouting current relatively quickly, the system can prevent at least a portion of the overcurrent from reaching and damaging one or more components associated with the system that are further downstream from the solid-state device or power source.

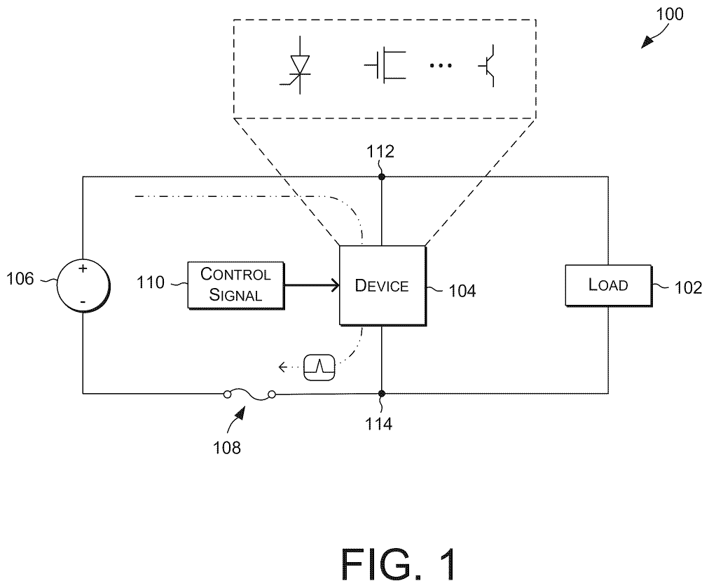

FIG. 1 illustrates an example protection circuit 100 (also referred to as “the protection system 100”) configured to protect a load 102 against an overcurrent according to one or more examples. The protection circuit 100 can include a device 104 (sometimes referred to as “solid-state device 104”) coupled in parallel with a power source 106 and/or the load 102 (which can include one or more components/systems/devices). The protection circuit 100 also includes a fuse 108 coupled in series with the load 102 and/or the power source 106. During normal operation, the solid-state device 104 is configured to operate in an inactive/off state, causing current to be routed to the load 102 and bypass the solid-state device 104. In response to an overcurrent event, the solid-state device 104 is configured to operate in an active state, causing current to bypass the load 102 and be rerouted to the fuse 108 through the solid-state device 104. The solid-state device 104 can reroute some or all of the current. The fuse 108 can be designed/configured to permanently or temporarily activate/blow to interrupt the circuit. In examples, the solid-state device 104 can be configured to activate/switch more quickly than a predetermined amount of time or an amount of time needed to activate the fuse 108. Thus, by using the solid-state device 104, current can be quickly rerouted to prevent the overcurrent from reaching and potentially damaging the load 102, while also providing adequate time for the fuse 108 to activate to interrupt the protection circuit 100. However, in other cases the solid-state device 104 can be configured to activate slower or in the same amount of time as that needed to activate the fuse 108. Although the load 102 and power source 106 are shown in FIG. 1, the protection circuit 100 may not include these elements but be configured to couple to such elements.

An overcurrent (sometimes referred to as “an overcurrent event/condition”) can generally refer to an undesired/abnormal current condition where electrical current exceeds the safe operating limit or a designated threshold of a circuit or component. In examples, an overcurrent is a situation where an amount of current is greater than a threshold designated as an operating limit. An overcurrent can include a current spike (e.g., a sudden, sharp increases in current, which may be a short-duration event less than a threshold), a current surge (e.g., a long-duration or longer-duration increase in current, such as current remaining above a threshold for more than a threshold amount of time), a short circuit (e.g., an overcurrent due to a low-resistance path), an overload (e.g., a sustained current exceeding a threshold), etc. In examples, an overcurrent is caused by a short or another event; however, an overcurrent can be caused in other manners.

The solid-state device 104 (sometime referred to as “device 104,” “actuated device 104,” or “switchable device 104”) is configured to change states according to a switching time (also referred to as “switching speed” or “activation time/speed”). The switching time indicates how quickly the solid-state device 104 can change states/modes, such as an amount of time (i.e., period of time) to transition from an inactive state to an active state, or vice versa. For instance, the switching time can refer to a period of time starting when a control signal is received at the solid-state device 104 to transition to an active state and ending when the solid-state device 104 has transitioned to the active state. In some cases, the solid-state device 104 can assist in mitigating/reducing nuisance tripping of the system, which can be caused by external or internal noise that does not actually represent a danger to the system. In examples, the switching time of the solid-state device 104 is less than a threshold amount of time. In some illustrations, the switching time is less than 1 millisecond, 10 microseconds (μs), 5 μs, 1 μs, 500 nanoseconds (ns), 400 ns, 300 ns, 200 ns, 100 ns, 50 ns, etc. In some cases, the switching time is in a range of 1-100 μs, 10-500 ns, 10 ns-5 μs, etc.

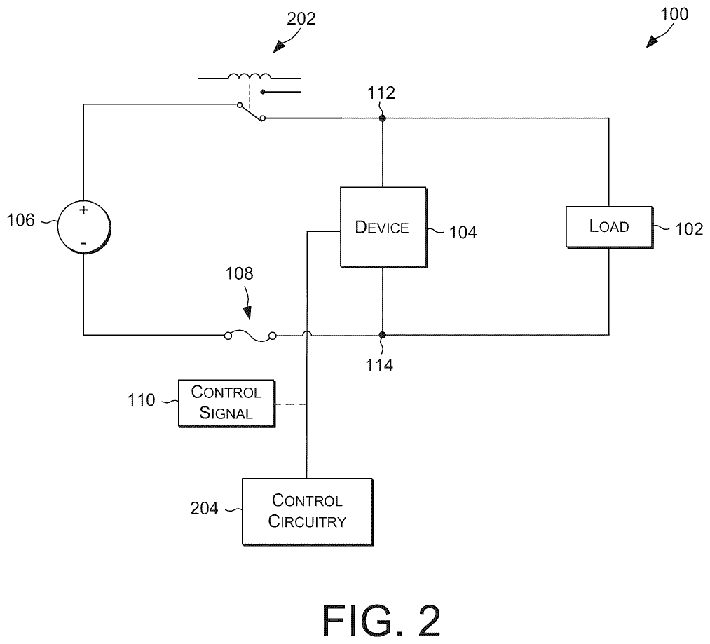

An active state of the solid-state device 104 generally refers to a conducting, current flowing, on, or closed switch/circuit state. Meanwhile, an inactive state of the solid-state device 104 generally refers to a non-conducting, current blocking, off, or open circuit/switch state. In examples, the solid-state device 104 operates like a switch to permit current flow in an active state and inhibit current flow in an inactive state. The solid-state device 104 can change states based on receiving a control signal 110, as shown in FIG. 1. The control signal 110 can be sent from a component that is configured to detect an overcurrent, as discussed in further detail below in reference to FIG. 2. Although various examples discuss sending a control signal to the solid-state device 104 to change the state of the solid-state device 104 from an inactive state to an active state, a control signal can similarly be sent to change from an active state to an inactive state. A control signal can be constantly applied/sent or applied/sent for a duration of time.

The solid-state device 104 can have certain characteristics to handle more than a threshold number of amperes/volts. For instance, the solid-state device 104 can have more than a certain mass/size (e.g., thermal mass) to handle relatively high amperes/volts for more than a threshold amount of time, which might occur in some overcurrent events. In examples, the solid-state device 104 is sized/designed to handle more than 5,000 amperes, 10,000 amperes, 20,000 amperes, 50,000 amperes, 100,000 amperes etc., such that a relatively large overcurrent can pass therethrough without undesirable effects.

The solid-state device 104 can be configured to reroute some or all of an overcurrent within the protection circuit 100. For example, when operating in an active state, the solid-state device 104 can shunt/route all or some of an overcurrent generated at the power source 106 along a parallel path to the load 102. In some examples, once the fuse 108 activates to interrupt current through the protection circuit 100, the solid-state device 104 clears/resets to an inactive state. That is, the activation of the fuse 108 can cause the solid-state device 104 to change back to the inactive state, thereby enabling/allowing the protection circuit 100 to reset to a default configuration where current can again flow to the load 102 once the fuse 108 is replaced or reset.

The solid-state device 104 can include a transistor, thyristor, Insulated Gate Bipolar Transistors (IGBTs), Solid-State Relay (SSR), diode, etc. A thyristor can include a Silicon-Controlled Rectifier (SCR), Triode for Alternating Current (TRIAC), Diode for Alternating Current (DIAC), Silicon-Controlled Switch (SCS), etc. A transistor can include a field-effect transistor (FET) (e.g., N-type or P-type device), a junction FET (JFET), insulated gate FET (e.g., a metal-oxide-semiconductor FET (MOSFET), a complementary metal-oxide-semiconductor (CMOS), etc.), and so on. Further, a transistor can include a Bipolar Junction Transistor (BJT) (e.g., an NPN transistor, a PNP transistor, etc.). Although many examples discuss the protection circuit 100 in the context of implementing the solid-state device 104, the protection circuit 100 can be implemented with a mechanically-actuated device/switch (e.g., mechanical switch), pyro-actuated device/switch, or another actuated/switchable device configured to selectively activate, such as a relay, contactor, pyro-actuated switch, etc. For ease of illustration, element 104 is shown as the solid-state device 104 in various figures; however, element 104 can be implemented with a variety of types of devices.

As shown, the solid-state device 104 is coupled between a first node 112 and a second node 114. The first node 112 is coupled to/between a first end/terminal/contact of the power source 106 and a first side/contact of the load 102, while the second node 114 is coupled to/between a first end/contact of the fuse 108 and a second side/contact of the load 102. Thus, a first end of the solid-state device 104 is coupled to (e.g., directly connected to) the first end of the power source 106 and first side of the load 102, while a second end of the solid-state device 104 is coupled to a first end of the fuse 108 and second side of the load 102. Further, a second side of the fuse 108 is coupled to a second end/terminal/contact of the power source 106. The term “coupled”, as generally used herein, refers to two or more elements that may be either directly connected, or connected by way of one or more intermediate elements. Thus, although various elements are illustrated in FIG. 1 as being directly coupled to each other, one or more intermediate elements can be disposed there between.

As noted above, the fuse 108 can be configured/designed to activate to interrupt current flow through the protection circuit 100. Fuse activation can refer to the process in which the current running through the fuse 108 exceeds a threshold amount (e.g., rated value) for more than a threshold amount of time, causing the fuse 108 to break/interrupt the circuit. In other words, fuse activation is the action of disconnecting electrical circuitry by opening a path of current flow. Fuse activation can also be referred to as fuse response, fuse opening, or current interruption. The fuse 108 can be configured to temporarily activate (e.g., change to a non-permanent, reversible, switchable, etc. state) or permanently activate (e.g., change to an irreversible, permanent, etc. state). The fuse 108 can be implemented as a thermal fuse, cartridge fuse, glass tube fuse, blade fuse, pyrotechnic fuse, mechanically-actuated fuse, contactor-pyro fuse hybrid, etc.

The fuse 108 is configured to activate according to a fuse response time (also referred to as “fuse response speed” or “fuse activation time/speed”). The fuse response time indicates how quickly the fuse 108 activates. For instance, the fuse response time can refer to a period of time starting when a current exceeds a threshold/rated amount and ending when the fuse 108 has interrupted the circuit (e.g., blown). In examples, the fuse 108 can interrupt a circuit when current exceeds a threshold amount for a fuse response time. In some illustrations, the fuse response time is more than 100 μs, 200 μs, 300 μs, 400 μs, 500 μs, 1 ms, 100 ms, 200 ms, 300 ms, 1 second, etc. depending on the fuse characteristic and/or the overcurrent presented.

In examples, the fuse 108 is oversized/overdesigned to the characteristics of the protection circuit 100. For instance, the load 102 can be rated to handle no more than a certain number of amperes, while the fuse 108 can be configured to activate at more than the certain number of amperes (e.g., rated at 2, 5, 10, etc. times that number of amperes). By using an oversized fuse, the protection circuit 100 can allow for a higher overcurrent while still protecting the load 102. Further, in some cases a fuse can degrade over time to make the fuse more sensitive to unnecessary activation or provide other negative effects. An oversized fuse can account for fuse degradation and ultimately provide a larger tolerance. Moreover, in some cases an oversized fuse can be more cost-effective. Although an oversized fuse can take longer to blow in some cases, the configuration of the protection circuit 100 can quickly reroute an overcurrent to prevent damage to the load 102, while providing sufficient time for an oversized fuse to blow. Thus, such configuration of the protection circuit 100 allows a variety of fuses to be selected to satisfy various desired design characteristics.

The power source 106 (also referred to as “the voltage source 106”) can be configured to provide power to the load 102 and/or other components. In examples, the load 102 includes a motor, inverter, heater, air conditioner, or other components. The power source 106 can be a Direct Current (DC) or Alternating Current (AC) power source. In examples, the power source 106 is a battery, such as a lithium-ion battery, lithium-polymer battery, nickel-cadmium, Nickel-Metal Hydride battery, zinc-carbon battery, silver oxide battery, lead-acid battery, etc. Further, in some cases, the power source 106 is a supercapacitor or another device. In examples, the power source 106 is a high-density battery, such as a high-energy-density battery or high-power-density battery configured to store/deliver more than a threshold amount of energy/power. In some illustrations, the protection circuit 100 is implemented on an electric vehicle with a high-density battery. However, the protection circuit 100 can be implemented on other types of electric vehicles and/or in other devices/systems.

In examples, the solid-state device 104 and/or fuse 108 are located closer to the power source 106 than the load 102. For instance, the solid-state device 104 and/or fuse 108 can be located/distanced within a predetermined proximity to the power source 106 and/or beyond a proximity/distance to the load 102. In one illustration, the solid-state device 104 and/or fuse 108 are implemented on the same device, wherein such device is configured to couple between the power source 106 and load 102. Here, the solid-state device 104 and/or fuse 108 can be representative of the protection circuit 100. In another illustration, the solid-state device 104 and/or fuse 108 are implemented as part of the power source 106.

In examples, the protection circuit 100 is implemented in high-voltage applications, such as systems capable of handling/providing more than 100 volts (V), 200V, 400V, 600V, 800V, etc. However, the protection circuit 100 can be implemented in other contexts. Further, in examples, the solid-state device 104 is rated to handle at least 5,000 amperes, 10,000 amperes, 20,000 amperes, 50,000 amperes, 100,000 amperes etc. Moreover, in examples, the fuse 108 is rated to activate at 400 amperes, 800 amperes, 1,000 amperes, 2,000 amperes, 5,000 amperes, etc.

In examples, the protection circuit 100 enables an overcurrent to be quickly rerouted to prevent the overcurrent from damaging components of a system, while providing sufficient time to open the circuit. To illustrate, the solid-state device 104 can be configured to operate more quickly than the fuse 108 or a threshold amount of time, such that an overcurrent is quickly rerouted to bypass the load 102 and avoid damaging the load 102, while providing sufficient time for the fuse 108 to activate and interrupt the circuit. As such, a fuse response time of the fuse 108 can be greater than a switching time of the solid-state device 104, in some cases by a significant amount (e.g., 2 times longer, 10 times longer, 1,000 times longer, etc.).

Although various figures illustrate single elements, such elements can be representative of any number of elements. For example, the power source 106 can represent one or more power sources, the load 102 can represent one or more loads/components, the solid-state device 104 can represent one or more solid-state devices, and/or the fuse 108 can represent one or more fuses.

FIG. 2 illustrates an example where the protection circuit 100 includes a relay 202 configured to control power provided to the load 102 and control circuitry 204 configured to control a state of the solid-state device 104 according to one or more examples. As shown, the relay 202 is coupled between the power source 106 and node 112. The relay 202 is coupled in series with the load 102 and/or the fuse 108. Further, the control circuitry 204 is coupled to the solid-state device 104. Although positioned in this configuration shown in FIG. 2, the relay 202 and/or the control circuitry 204 can be positioned in other locations within the protection circuit 100. In examples, the relay 202 and/or the control circuitry 204 are implemented close to (within a predetermined distance) the power source 106, within a device coupled to the power source 106, or within the power source 106. However, the relay 202 and/or the control circuitry 204 can be implemented elsewhere.

The relay 202 can be configured as an electrically operated switch that controls power provided to the load 102. The relay 202 can be configured to selectively couple the power source 106 to the load 102. The relay 202 can include an Electromechanical Relay (EMR), Solid-State Relay (SSR), Time-Delay Relay (TDR), latching relay, thermal relay, polarized relay, safety relay, contractor, etc.

The control circuitry 204 (also referred to as “the controller 204”) can be configured to detect an overcurrent. For instance, the control circuitry 204 can be configured to detect/determine that current has increased beyond a threshold for more than a threshold amount of time. The overcurrent can originate from the power source 106 or another component. In response to detecting an overcurrent, the control circuitry 204 can generate the control signal 110 and provide/send the control signal 110 to the solid-state device 104 to control the solid-state device 104, such as to cause the solid-state device 104 to change to an active state and route the overcurrent to the fuse 108 while bypassing the load 102. Although discussed in the context of switching the solid-state device 104 to an active state, the control signal 110 can alternatively, or additionally (a second control signal), be used to switch the solid-state device 104 to an inactive state. In one illustration, the control circuitry 204 can generate a bias voltage and apply the bias voltage (in the form of the control signal 110) to control the solid-state device 104. For instance, the control circuitry 204 can provide the bias voltage to a gate of the solid-state device 104. The bias voltage can be at a level (e.g., more or less than a threshold) to place the solid-state device 104 in an active state, enabling a current to flow through the solid-state device 104. In examples, the control circuitry 204 can also provide a biasing voltage to other elements of the solid-state device 104 besides the gate, such as a source, drain, emitter, collector, body, base, etc.

In examples, the control circuitry 204 is associated with the power source 106. For instance, the control circuitry 204 can be part of a Battery Management System (BMS) or Protection Circuit Module (PCM) of the power source 106, such as when the power source 106 is a battery (e.g., a rechargeable or non-rechargeable battery). The BMS/PCM can manage the battery, such as by monitoring various parameters of the battery, controlling an environment of the battery, reporting data regarding the battery, etc. To illustrate, the control circuitry 204 can be part of a BMS of the power source 106 and configured to monitor current provided by the power source 106. In response to detecting an overcurrent, the BMS can generate and provide the control signal 110. In some cases, the solid-state device 104 and/or the fuse 108 can additionally be part of the BMS/PCM or coupled closely to the BMS/PCM, such as within a battery compartment housing a battery. Although the BMS/PCM are discussed in some examples, other types of systems can be implemented, such as an Energy Management System (EMS), Power Management System (PMS), etc.

The control circuitry 204 can include one or more processors, such as one or more central processing units (CPUs), one or more microprocessors, one or more graphics processing units (GPUs), one or more digital signal processors (DSPs), one or more microcontrollers, and/or other processing circuitry. Alternatively, or additionally, the control circuitry 204 can include one or more application specific integrated circuits (ASIC), one or more field-programmable gate arrays (FPGAs), one or more program-specific standard products (ASSPs), one or more complex programmable logic devices (CPLDs), and/or the like. The control circuitry 204 can be configured to execute one or more instructions stored in data storage to thereby perform one or more operations to implement various functionality discussed herein.

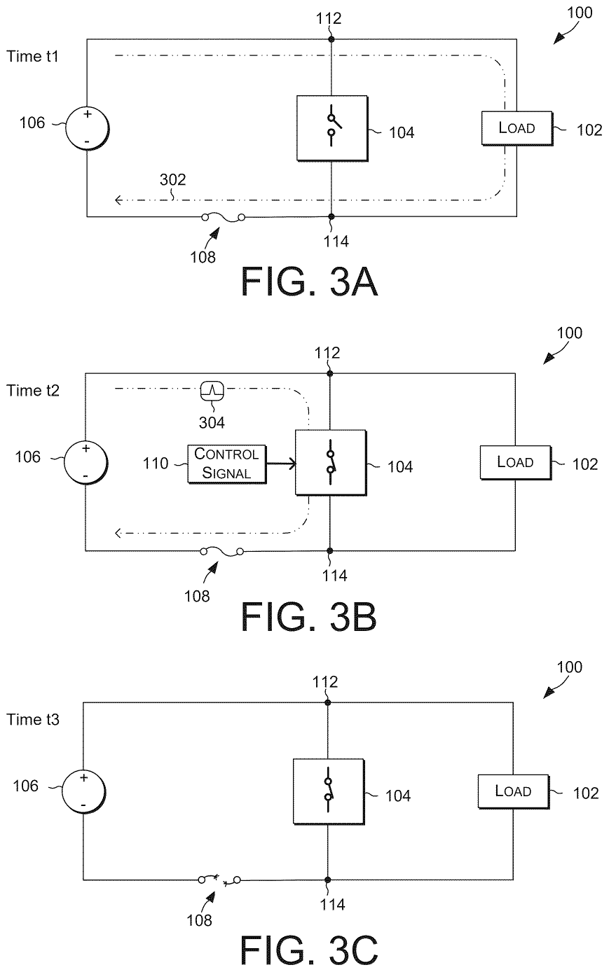

FIGS. 3A-3C illustrate example states of the protection circuit 100 during an overcurrent event according to one or more examples. In these examples, the solid-state device 104 is shown with a switch for illustrative purposes to indicate when current flows therethrough. However, the solid-state device 104 can be configured to operate in other manners.

FIG. 3A illustrates the protection circuit 100 at time t1 during normal operation when current 302 flows at a normal rate (e.g., less than a threshold number of amps). Here, the solid-state device 104 is operating in an inactive/open state where the current 302 passes to the load 102 and bypasses the solid-state device 104 (e.g., current does not flow through the solid-state device 104). In response to detecting an overcurrent 304 at time t2, the control signal 110 is sent to the solid-state device 104 to switch the solid-state device 104 to an active/closed state, as shown in FIG. 3B. Here, at least a portion of the overcurrent 304 is routed through the solid-state device 104, bypassing a path to the load 102 (e.g., bypassing a path from the node 112 to the load 102 and from the load 102 to the node 114). For instance, a substantial, majority, or other portion of the overcurrent 304 can be rerouted. In this example, the solid-state device 104 is configured to activate quicker than the fuse 108. Thus, the overcurrent 304 passes through the fuse 108 for some amount of time until the fuse 108 interrupts current flow at time t3 (e.g., the fuse 108 blows), as shown in FIG. 3C. Once the fuse 108 activates/blows at time t3, current ceases to flow through the protection circuit 100. The fuse 108 can be configured to temporarily activate/blow or permanently activate/blow. In the case of a temporary activation, the fuse 108 can be reset to enable current to flow therethrough again.

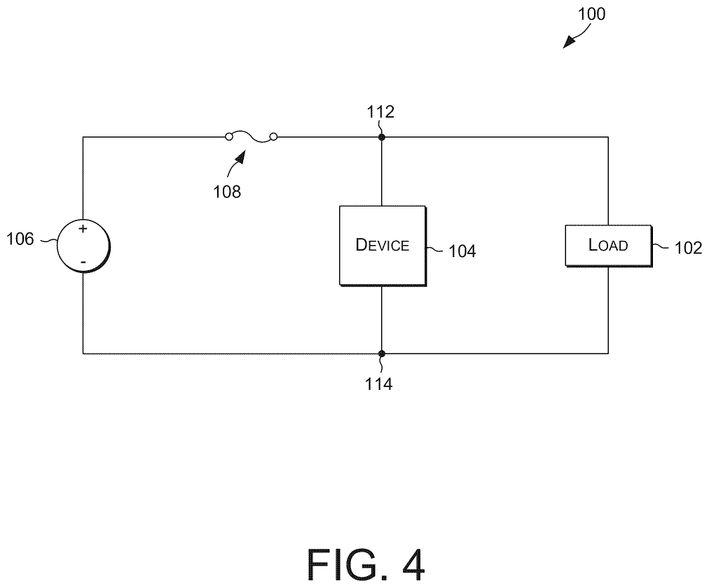

FIG. 4 illustrates an example where the protection circuit 100 includes the fuse 108 coupled between the power source 106 and the solid-state device 104 according to one or more examples. As shown, the fuse 108 is coupled between the power source 106 and the node 112. Although various configurations are illustrated, the fuse 108 can be disposed within the protection circuit 100 at other locations.

The detailed description is set forth with reference to the accompanying figures. In the figures, the left-most digit(s) of a reference number identifies the figure in which the reference number first appears. The use of the same reference numbers in different figures indicates similar or identical items.

### ADDITIONAL EXAMPLES

### Example 1

A protection circuit comprising: a fuse configured to couple in series with a load; and a device coupled to the fuse and configured to couple in parallel with the load, the device configured to, in response to an increase in current above a threshold, operate in an active state to route at least a portion of the current through the device and to the fuse, the device including at least one of a solid-state device, a mechanically-actuated device, or a pyro-actuated device.

### Example 2

The protection circuit of example 1, wherein a switching time of the device is less than a fuse response time of the fuse.

### Example 3

The protection circuit of example 1, wherein a switching time of the device is less than a threshold and a fuse response time of the fuse is greater than the threshold.

### Example 4

The protection circuit of example 1, wherein a fuse response time of the fuse is more than 200 μs.

### Example 5

The protection circuit of example 1, wherein the device is rated to handle more than 10,000 amperes.

### Example 6

The protection circuit of example 1, wherein the device is a thyristor.

### Example 7

The protection circuit of example 1, wherein the device is a silicon-controlled rectifier.

### Example 8

The protection circuit of example 1, wherein the fuse is a thermal fuse.

### Example 9

The protection circuit of example 1, wherein the device is coupled to a first node and a second node that are configured to couple to the load, and the fuse is coupled between the second node and a power source.

### Example 10

The protection circuit of example 9, wherein the power source is at least one of a high-energy-density battery or a high-power-density battery.

### Example 11

The protection circuit of example 1, further comprising: control circuitry coupled to the device and configured to detect an overcurrent; and send a control signal to the device to cause the device to operate in the active state.

### Example 12

The protection circuit of example 1, wherein the protection circuit is disposed on a battery management system.

### Example 13

A circuit comprising: a fuse configured to couple in series with a load; and a device coupled to the fuse and configured to couple in parallel with the load, the device configured to, based on an overcurrent event, switch the circuit to a load bypass state to cause at least a portion of an overcurrent to pass through the device and reach the fuse without flowing to the load.

### Example 14

The circuit of example 13, wherein a switching time of the device is less than a fuse response time of the fuse.

### Example 15

The circuit of example 13, wherein a switching time of the device is less than a threshold and a fuse response time of the fuse is greater than the threshold.

### Example 16

The circuit of example 13, wherein a fuse response time of the fuse is more than 200 μs.

### Example 17

The circuit of example 13, wherein the device is rated to handle more than 10,000 amperes.

### Example 18

The circuit of example 13, wherein the device is a thyristor.

### Example 19

The circuit of example 13, wherein the device is a silicon-controlled rectifier.

### Example 20

The circuit of example 13, wherein the fuse is a thermal fuse.

### Example 21

A method comprising: detecting an overcurrent in a circuit having a fuse coupled in series with a load and a device coupled to the fuse and in parallel with the load; and switching the device to a conducting state to cause at least a portion of the overcurrent to bypass the load and pass through the fuse.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, refer to this application as a whole and not to any particular portions of this application. Where the context permits, words in the above Description using the singular or plural number may also include the plural or singular number respectively.

The above description of examples of the disclosure is not intended to be exhaustive or to limit the disclosure to the precise form disclosed above. While specific examples, and examples, are described above for illustrative purposes, various equivalent modifications are possible within the scope of the disclosure, as those skilled in the relevant art will recognize. For example, while processes or blocks may be presented in a given order, alternative examples may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks may be at times shown as being performed in series, these processes or blocks may instead be performed in parallel or at different times.

The features described herein can be applied to other systems, not necessarily the system described above. The elements and acts of the various examples described above can be combined to provide further examples.

While some examples have been described, these examples have been presented by way of example only, and are not intended to limit the scope of the disclosure. Indeed, the techniques and systems described herein may be embodied in a variety of other forms; furthermore, various omissions, substitutions and changes in the form of the techniques and systems described herein may be made without departing from the spirit of the disclosure. Claims and their equivalents are intended to cover such forms or modifications as would fall within the scope and spirit of the disclosure.

What is claimed is:

1. A protection circuit comprising:
a fuse configured to couple in series with a load; and
a device coupled to the fuse and configured to couple in parallel with the load, the device configured to, in response to an increase in current above a threshold, operate in an active state to route at least a portion of the current through the device and to the fuse, the device including at least one of a solid-state device, a mechanically-actuated device, or a pyro-actuated device.

2. The protection circuit of claim 1, wherein a switching time of the device is less than a fuse response time of the fuse.

3. The protection circuit of claim 1, wherein a switching time of the device is less than a threshold and a fuse response time of the fuse is greater than the threshold.

4. The protection circuit of claim 1, wherein a fuse response time of the fuse is more than 200 μs.

5. The protection circuit of claim 1, wherein the device is rated to handle more than 10,000 amperes.

6. The protection circuit of claim 1, wherein the device is a thyristor.

7. The protection circuit of claim 1, wherein the device is a silicon-controlled rectifier.

8. The protection circuit of claim 1, wherein the fuse is a thermal fuse.

9. The protection circuit of claim 1, wherein the device is coupled to a first node and a second node that are configured to couple to the load, and the fuse is coupled between the second node and a power source.

10. The protection circuit of claim 9, wherein the power source is at least one of a high-energy-density battery or a high-power-density battery.

11. The protection circuit of claim 1, further comprising:
control circuitry coupled to the device and configured to detect an overcurrent; and
send a control signal to the device to cause the device to operate in the active state.

12. The protection circuit of claim 1, wherein the protection circuit is disposed on a battery management system.

13. A circuit comprising:
a fuse configured to couple in series with a load; and
a device coupled to the fuse and configured to couple in parallel with the load, the device configured to, based on an overcurrent event, switch the circuit to a load bypass state to cause at least a portion of an overcurrent to pass through the device and reach the fuse without flowing to the load.

14. The circuit of claim 13, wherein a switching time of the device is less than a fuse response time of the fuse.

15. The circuit of claim 13, wherein a switching time of the device is less than a threshold and a fuse response time of the fuse is greater than the threshold.

16. The circuit of claim 13, wherein a fuse response time of the fuse is more than 200 μs.

17. The circuit of claim 13, wherein the device is rated to handle more than 10,000 amperes.

18. The circuit of claim 13, wherein the device is a thyristor.

19. The circuit of claim 13, wherein the device is a silicon-controlled rectifier.

20. The circuit of claim 13, wherein the fuse is a thermal fuse.
